(19) United States
(12) Patent Application Publication
(10) Pub. No.: US 2011/0083042 A1
(43) Pub. Date: Apr. 7, 2011

(54) Touch Control Device and Controller, Testing Method and System of the Same

(76) Inventors: Hui-Hung Chang, Keelung City (TW); Meng-Hsiu Wu, Hsinchu City (TW); Hsieh-Yi Wu, Hsinchu County (TW)

(21) Appl. No.: 12/696,064

(22) Filed: Jan. 29, 2010

(30) Foreign Application Priority Data
Oct. 7, 2009 (TW) 098133944

(51) Int. Cl. G06F 11/07; G06F 3/041

(52) U.S. Cl. 714/31; 345/173; 714/E11.024; 714/32

(57) ABSTRACT

A testing method for testing a touch control device is disclosed. In a controller of the touch control device, a processor executes an operating firmware to realize a touch control function. The testing method includes a host testing device outputting a test requirement command to the controller, the controller outputting data corresponding to an operating stage selected from a plurality of operating stages of executing the operating firmware to the host testing device according to the test requirement command, and the host testing device determining an operating status of the touch device according to data provided by the touch control device.

### BACKGROUND OF THE INVENTION

1. Field of the Invention

The present invention relates to a touch control device and related controller, testing method and testing system, and more particularly, to a touch control device and related controller, testing method and testing system achieving on-system debugging.

2. Description of the Prior Art

A touch panel has merits such as convenient operation, quick response and saving space, and thus has been widely used in a variety of consumer electronics products, e.g. personal digital assistants (PDAs), smart mobile communication devices, laptops and point of sale (POS) systems. A capacitive touch control technique with merits such as stable performance, great sensitivity and durability is one of the most popular conventional techniques, which realizes touch control function according to capacitance variation generated by electrostatic force when a touch panel is touched by human body.

Please refer to FIG. 1, which is a functional block diagram of a conventional capacitive touch control device 10. The capacitive touch control device 10 is utilized for sensing touch behaviors of a user, and outputting a corresponding motion information packet P_MV to a front-end controller 100. The front-end controller 100 can be a controller of a front-end device such as a digital camera, a mobile phone, a laptop, and executes a control operation required by the user according to the motion information packet P_MV. The capacitive touch control device 10 includes a touch panel 102, an analog to digital converter (ADC) 104 and a controller 106. The touch panel 102 includes a sensing circuit and a plurality of traces arranged as a matrix, and the sensing circuit senses capacitances of the traces. The ADC 104 converts the capacitances sensed by the touch panel 102 into digital data for the controller 106 to determine a touch event. The controller 106 compares the digital sensed data with an environment capacitance parameter, to determine whether a touch event occurs, where a touch event occurs, whether a touch event is over, etc., and determines a corresponding motion (or gesture) such as click, double clicks, horizontal slide, vertical slide, etc. according to different application requirements, to generate and output the motion information packet P_MV to the front-end controller 100, such that the front-end device can execute the operation required by the user.

Generally, functions of the controller 106 are realized by a system on chip (SoC); that is, the functions are transformed into firmware and stored in a memory, and then executed by a microprocessor. Meanwhile, in order to ensure the final product operating normally, the capacitive touch control device 10 needs to be passed a testing process before off-factory, to determine whether the sensed data and the environment capacitance parameter are correct under specific touch events. Since the testing process needs to acquire the sensed data and the environment capacitance parameter, which are different from the motion information packet P_MV generated by the controller 106 in a normal mode, a testing firmware needs to be added (programmed) in the controller 106 in advance, and is merely used in the testing process, for outputting required data. In detail, there are two stages for the controller 106 to process the sensed data: a raw data stage and an application data stage. In the raw data stage, the controller 106 compares the sensed data with the environment capacitance parameter, while in the application data stage, the controller 106 generates the motion information packet P_MV according to a comparison result of a former stage. In other words, the raw data stage is related to charging and discharging parameters of the touch panel 102 and the environment capacitance parameter, while the application data stage is related to application requirements. Therefore, in order to determine whether related parameters of the touch panel 102 are adjusted to ideal values, researchers design an extra testing firmware to convert data such as the sensed data, the environment capacitance parameter, etc. into a raw data packet, and output to an external host device for the researchers for further study.

In other words, the controller 106 includes an operating firmware for generating the motion information packet P_MV and a testing firmware for performing the testing process. In such a condition, it is necessary to add memory capacity, which increases production cost. Moreover, since the testing firmware and the operating firmware are different or merely partial similar, an execution result of the testing firmware only reflects an operating status of the touch panel 102 in a testing stage, but is not related to an execution result of the operating firmware, i.e. even if the testing result is normal, there may be operating faults after off-factory. In other words, on-system debugging is not achieved.

In addition, in order to activate two different firmwares, a software interface of the host device needs to include two operating modes, which causes inconvenience, low efficiency, high cost, etc.

The above description is related to the condition that the controller 106 only executes a single testing process. In practical, different testing firmwares need to be installed in the controller 106 for different testing processes. In other words, as the testing processes to be executed increases, the memory capacity in the controller 106 must be correspondingly increased, for storing more testing firmwares. Certainly, extra operating modes need to be added in the software interface of the host device as well. Accordingly, production cost, efficiency, etc. are significantly affected.

Therefore, more than two sets of firmware need to be designed for the testing process of the capacitive touch control device in the prior art, which increases production cost, fails to reflect the complete operating status, and causes disadvantages in product competitiveness.

### SUMMARY OF THE INVENTION

It is therefore an objective of the present invention to provide a touch control device and controller, testing method and testing system of the same.

The present invention discloses a testing method for testing a touch control device. A processor executes an operating firmware to realize a touch control function in a controller of the touch control device. The testing method includes a host device outputting a test requirement command to the controller, the controller outputting data corresponding to an operating stage selected from a plurality of operating stages of the processor executing the operating firmware to the host device according to the test requirement command, and the host device determining an operating status of the touch control device according to data outputted by the controller.

The present invention further discloses a testing system for testing a touch control device. A processor executes an operating firmware to realize a touch control function in a controller of the touch control device. The testing system includes a host device, for outputting a test requirement command, and a data acquisition module, installed in the controller, for outputting data corresponding to an operating stage selected from a plurality of operating stages of the processor executing the operating firmware to the host device according to the test requirement command.

The present invention further discloses a controller for a touch control device. The controller includes a storage device, for storage a operating firmware, a processor, for executing the operating firmware, to realize a touch control function of the touch control device, and a data acquisition module, for outputting data corresponding to an operating stage selected from a plurality of operating stages of the processor executing the operating firmware according to a test requirement command.

The present invention further discloses a touch control device for an electronic device. The touch control device includes a touch panel, for sensing a plurality of capacitances of a plurality of traces, an analog to digital converter (ADC), for converting the plurality of capacitances sensed by the touch panel into a plurality of digital sensed data, and a controller. The controller includes a storage device, for storing an operating firmware, a processor, for executing the operating firmware, to output at least one motion information packet to a front-end controller of the electronic device according to the plurality of sensed data, and a data acquisition module, for outputting data corresponding to an operating stage selected from a plurality of operating stages of the processor executing the operating firmware according to a test requirement command

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a conventional capacitive touch control device.

FIG. 2A is a schematic diagram of a testing system according to an embodiment of the present invention.

FIG. 2B is a schematic diagram of a touch control device shown in FIG. 2A.

FIG. 3 is a schematic diagram of a data acquisition module according to an embodiment of the present invention.

FIG. 4 is a schematic diagram of a process according to an embodiment of the present invention.

FIG. 5 is a schematic diagram of another process according to an embodiment of the present invention.

### DETAILED DESCRIPTION

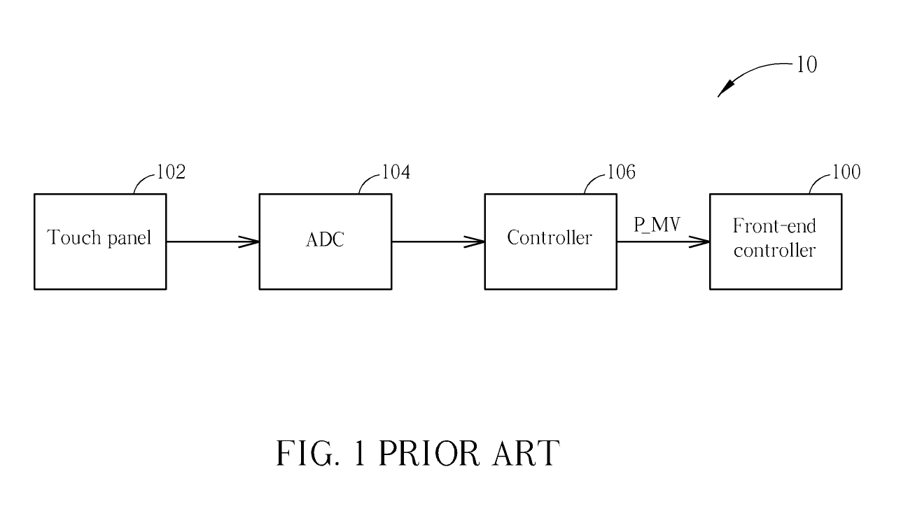

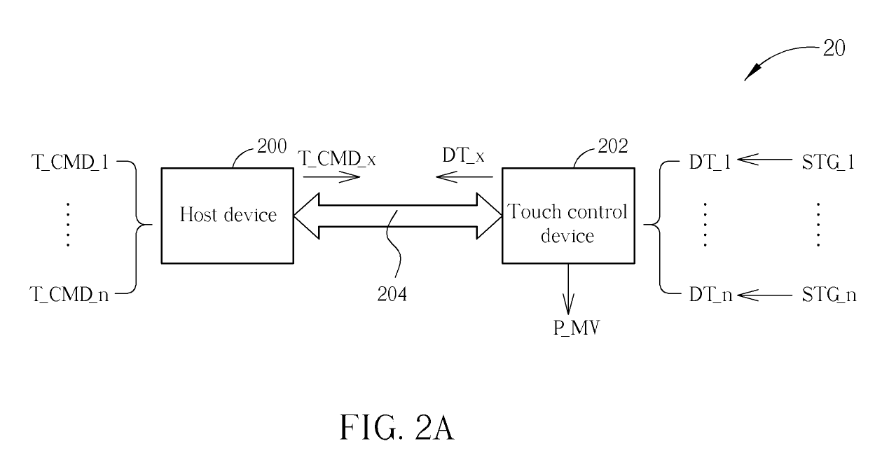

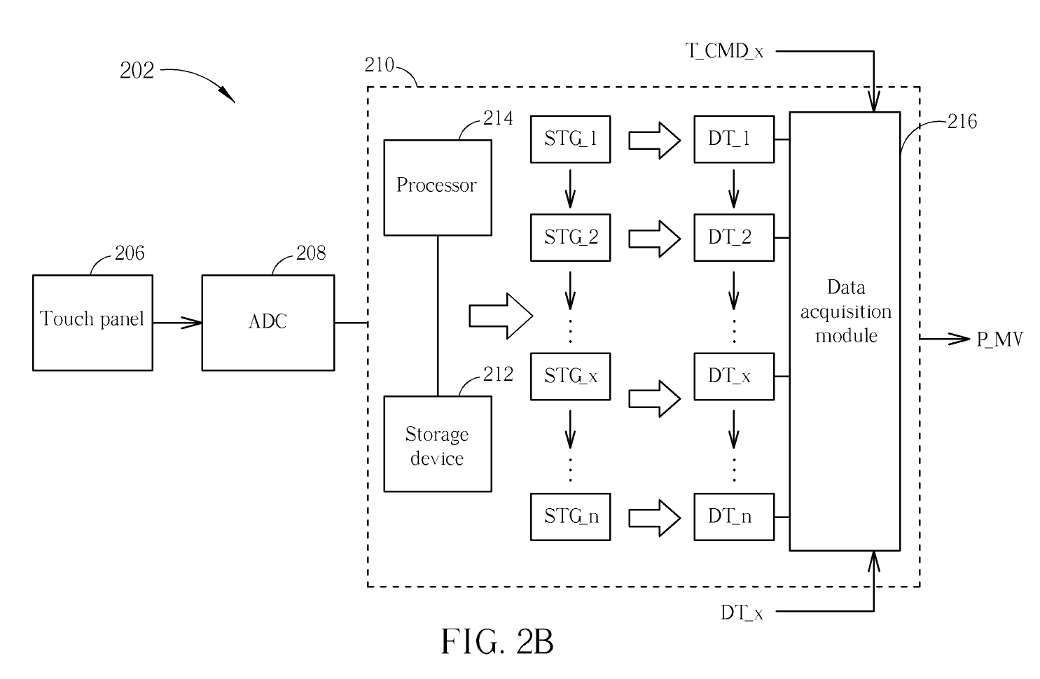

Please refer to FIG. 2A, which is a schematic diagram of a testing system 20 according to an embodiment of the present invention. The testing system 20 includes a host device 200, a touch control device 202 and a connection interface 204. The structure and operating principles of the touch control device 202 are similar to those of the capacitive touch control device 10 shown in FIG. 1, for outputting the motion information packet P_MV to the front-end controller (not shown in FIG. 2A). The difference between the capacitive touch control device 10 and the touch control device 202 is that for the testing process, the testing firmware different from the operating firmware is included in the controller 106 of the capacitive touch control device 10, while no testing firmware is needed in the touch control device 202. When testing the touch control device 202, an engineer can operate the host device 200 to select a test requirement command T_CMD_x from test requirement commands T_CMD_1˜T_CMD_n, and output the test requirement command T_CMD_x to the touch control device 202 via the connection interface 204. The test requirement commands T_CMD_1˜T_CMD_n are corresponding to required operating stages STG_1˜STG_n when the touch control device 202 outputs the motion information packet P_MV, and used for requesting the touch control device 202 to transmit data DT_1˜DT_n corresponding to the operating stages STG_1˜STG_n back. Therefore, after the touch control device 202 receives the test requirement command T_CMD_x, the touch control device 202 transmits data DT_x corresponding to an operating stage STG_x back to the host device 200 via the connection interface 204.

Please refer to FIG. 2B, which is a schematic diagram of the touch control device 202 shown in FIG. 2A. Similar to the capacitive touch control device 10, the touch control device 202 includes a touch panel 206, an analog to digital converter (ADC) 208 and a controller 210. Structures and operating principles of the touch panel 206 and the ADC 208 can be identical to those of the touch panel 102 and ADC 104 shown in FIG. 1, i.e. the controller 106 can be replaced by the controller 210, to achieve purposes of the present invention. The controller 210 includes a storage device 212, a processor 214 and a data acquisition module 216. The storage device 212 stores an operating firmware FRM, which is central operating logic of the touch control device 202, and the processor 214 executes the operating firmware FRM to realize a touch control function. Processes of the processor 214 executing the operating firmware FRM are divided into the operating stages STG_1˜STG_n according to design or system requirements, etc., which have the corresponding data DT_1˜DT_n. The test requirement commands T_CMD_1˜T_CMD_n are utilized for acquiring the data DT_1˜DT_n. The test requirement command T_CMD_x outputted by the host device 200 is transferred to the data acquisition module 216, and the data acquisition module 216 identifies or interprets the test requirement command T_CMD_x, and transmits the corresponding data DT_x to the host device 200.

Generally, the operating stages STG_1˜STG_n can be seen as a result of a hierarchical design. The hierarchical design is a design solution, meaning that when the operating firmware FRM is designed, the operating firmware FRM is divided into multiple independent sub-operating firmwares first, and each of the sub-operating firmwares is designed and tested by researchers; after each sub-operating firmware is completed, all the sub-operating firmwares are assembled to obtain the operating firmware FRM. Such a hierarchical design concept is widely used in industry, for hardware design such as circuits, mechanisms, etc. as well as firmware design, in order to effectively enhance efficiency of research and development (R&D) and production test.

Noticeably, the number n of the operating stages STG_1˜STG_n or content of each operating stage is related to designs or requirements. For example, in one embodiment, the operating stage STG_1 is receiving the sensed data outputted by the ADC 208, the operating stage STG_2 is acquiring the environment capacitance parameter, the operating stage STG_3 is comparing the sensed data with the environment capacitance parameter, the operating stage STG_4 is determining whether a touch event occurs, etc.

Furthermore, the relation between the operating stages STG_1˜STG_n and the test requirement commands T_CMD_1˜T_CMD_n is one-on-one, i.e. a test requirement command T_CMD_1 is utilized for acquiring data DT_1 corresponding to the operating stage STG_1, a test requirement command T_CMD_2 is utilized for acquiring data DT_2 corresponding to the operating stage STG_2, etc. In other words, such relation can be seen as a certain “protocol” existed between or followed by the host device 200 and the touch control device 202. An objective of the protocol is to output specific data generated by the operating procedure of the touch control device 202 to the host device 200, and the realization method thereof includes using the test requirement commands predefined by the two peers (the host device 200 and the touch control device 202). Therefore, although the data acquisition module 216 is drawn outside the storage device 212 in FIG. 2B, the data acquisition module 216 can be a part of the operating firmware FRM in practical, or stored (or temporarily stored) in a plug-in program of the storage device 212. Certainly, the data acquisition module 216 can either be implemented by program code, or by hardware, depending on system requirements.

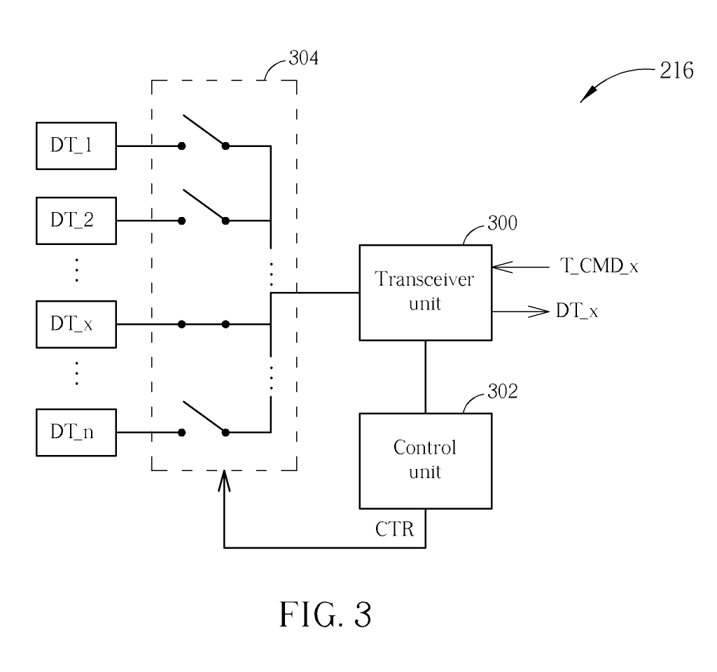

For example, please refer to FIG. 3, which is a schematic diagram of the data acquisition module 216 according to an embodiment of the present invention. As shown in FIG. 3, the data acquisition module 216 includes a transceiver unit 300, a control unit 302 and a switching unit 304. The transceiver unit 300 is utilized for receiving the test requirement command T_CMD_x outputted by the host device 200 via the connection interface 204, and transferring the test requirement command T_CMD_x to the control unit 302. The control unit 302 determines data required by the host device 200 is data DT_x according to the test requirement command T_CMD_x, and outputs a control signal CTR to switching unit 304 accordingly, such that the switching unit 304 outputs the data DT_x to the transceiver unit 300. Finally, the transceiver unit 300 transmits the data DT_x back to the host device 200, and the host device 200 determines an operating status of the touch control device 202 (or other elements) accordingly.

Therefore, by use of the data acquisition module 216 shown in FIG. 3, an engineer can control the host device 200 to output the test requirement command T_CMD_x to the touch control device 202, to request the data acquisition module 216 to transmit the data DT_x back, for further determining the related operating status. Noticeably, FIG. 3 illustrates a schematic diagram of the data acquisition module 216 according to a possible embodiment, whereby the switching unit 304 is represented by n switches, for illustrating the operating concept, but is not limited to such hardware circuits or equivalent software program code.

As can be seen from the above, the controller 210 of the touch control device 202 only includes the operating firmware FRM required for generating the motion information packet P_MV, and does not need to include any extra testing firmware used in the prior art. Therefore, comparing to the prior art, memory capacity of the touch control device 202 is reduced, so as reduce production cost. More importantly, the data DT_x transmitted back to the host device 200 by the touch control device 202 is data generated under a normal operation, i.e. the data DT_x can correctly reflect the operating status related to the touch control device 202. In such a condition, the host device 200 can correctly determine the operation of the touch control device 202 according to the received data DT_x, to achieve the objective of on-system debugging.

On the other hand, since no extra testing firmware is needed in the controller 210, the software interface of the host device 200 can only include a single operating mode, which enhances convenience and efficiency, and reduces software development cost.

Moreover, in the prior art, testing firmwares need to be added in the controller 106 for different testing processes, causing increase of production cost. In comparison, in the present invention, no extra testing firmware is needed, even for testing processes, as long as the test requirement commands are well defined, and therefore, production cost is significantly reduced. In such a condition, an engineer can easily acquire different data, to thoroughly determine the operating status of the touch control device 202. Therefore, except for the sensed data, the environment capacitance parameter (or the corresponding raw data packet) of the touch panel 206, the host device 200 can acquire other system data during executing procedures of the operating firmware FRM, for ensuring accuracy of each test.

Therefore, by use of the data acquisition module 216, the controller 210 only needs to include the operating firmware FRM required by the normal operation, and does not need to add testing firmware for testing processes, which reduces production cost and enhances testing efficiency. More importantly, the host device 200 can correctly determine the real operating status of the touch control device 202, to achieve the objective of on-system debugging. Noticeably, FIG. 2A, FIG. 2B and FIG. 3 are utilized for illustrating the spirit of the present invention, and modifications derived from the concept belong to the scope of the present invention. For example, the host device 200 can be a computer system, a digital personal assistant (PDA), etc. The connection interface 204 between the host device 200 and the touch control device 202 is not limited to any specific transmission interface, and can be USB, UART, etc. The test requirement commands T_CMD_1˜T_CMD_n can be data or information identified by the touch control device 202, such as digital packets, analog voltage signals, etc. Alterations of other elements can be properly derived, which can be done by those skilled in the art.

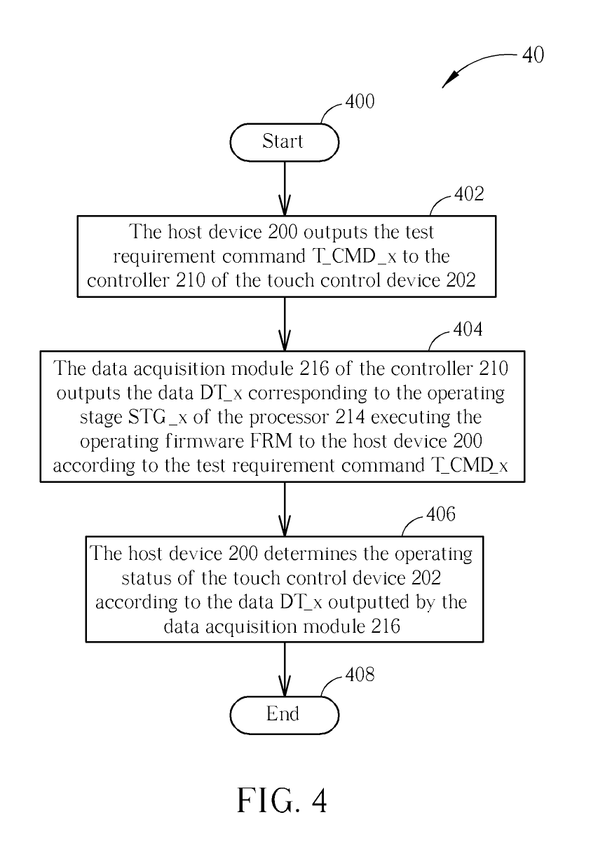

Furthermore, operations of the testing system 20 can be summarized into a process 40, as shown in FIG. 4, which includes the following steps:
Step 400: Start.
Step 402: The host device 200 outputs the test requirement command T_CMD_x to the controller 210 of the touch control device 202.
Step 404: The data acquisition module 216 of the controller 210 outputs the data DT_x corresponding to the operating stage STG_x of the processor 214 executing the operating firmware FRM to the host device 200 according to the test requirement command T_CMD_x.
Step 406: The host device 200 determines the operating status of the touch control device 202 according to the data DT_x outputted by the data acquisition module 216.
Step 408: End.

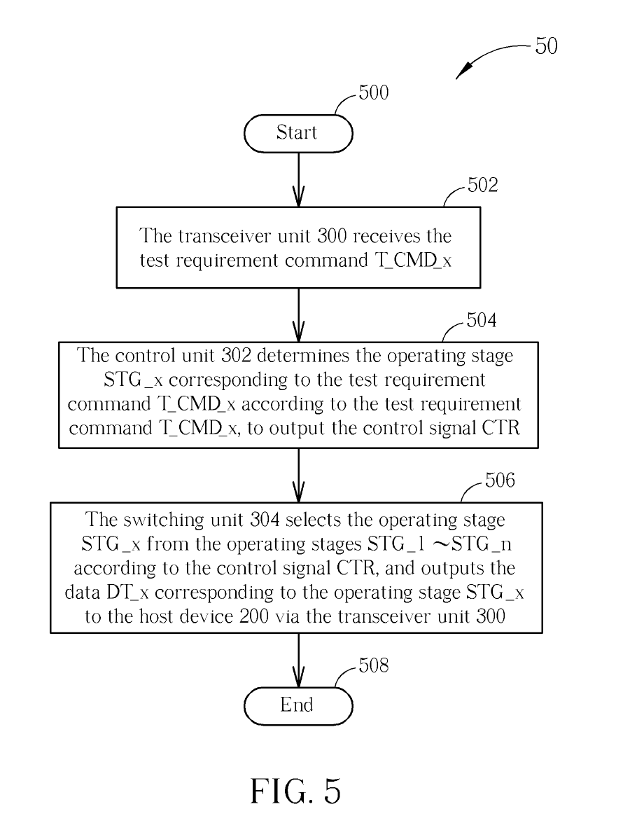

The process 40 illustrates the operation principles of the testing system 20, and detailed description can be referred to the above. The step 404 refers to operations of the data acquisition module 216, and can be further summarized into a process 50 according to the above description, as shown in FIG. 5. The process 50 includes the following steps:
Step 500: Start.
Step 502: The transceiver unit 300 receives the test requirement command T_CMD_x.
Step 504: The control unit 302 determines the operating stage STG_x corresponding to the test requirement command T_CMD_x according to the test requirement command T_CMD_x, to output the control signal CTR.
Step 506: The switching unit 304 selects the operating stage STG_x from the operating stages STG_1˜STG_n according to the control signal CTR, and outputs the data DT_x corresponding to the operating stage STG_x to the host device 200 via the transceiver unit 300.
Step 508: End.

In the prior art, the controller of the touch control device must include testing firmwares for different testing processes, causing increase of production cost. In comparison, the present invention utilizes “protocols” predefined between the host device and the touch control device, such that the host device can request the touch control device to respond specified data during operation. Therefore, in the present invention, the controller of the touch control device only includes firmware required for normal operation, and no extra testing firmware is needed, which reduces production cost and enhances testing efficiency. Meanwhile, the host device can correctly determine the real operating status of the touch control device, so as to achieve the objective of on system debugging. On the other hand, the concept of the present invention is not only available for testing of the touch control device, but also suitable for other electronic products.

To sum up, no extra testing firmware is added in the present invention, which reduces production cost and enhances testing efficiency. Meanwhile, the host device can correctly determine the real operating status of the touch control device, so as to achieve the objective of on-system debugging.

Those skilled in the art will readily observe that numerous modifications and alterations of the device and method may be made while retaining the teachings of the invention.

What is claimed is:

1. A testing method for testing a touch control device, a processor executing an operating firmware to realize a touch control function in a controller of the touch control device, the testing method comprising:
a host device outputting a test requirement command to the controller;
the controller outputting data corresponding to an operating stage selected from a plurality of operating stages of the processor executing the operating firmware to the host device according to the test requirement command; and
the host device determining an operating status of the touch control device according to data outputted by the controller.

2. The testing method of claim 1, wherein the controller determines data required by the host device according to the test requirement command, to select the operating stage from the plurality of operating stages of the processor executing the operating firmware and output data corresponding to the operating stage to the host device.

3. The testing method of claim 1, wherein meanings of the plurality of operating stages are predefined in the host device and the controller.

4. A testing system for testing a touch control device, a processor executing an operating firmware to realize a touch control function in a controller of the touch control device, the testing system comprising:
a host device, for outputting a test requirement command; and
a data acquisition module, installed in the controller, for outputting data corresponding to an operating stage selected from a plurality of operating stages of the processor executing the operating firmware to the host device according to the test requirement command.

5. The testing system of claim 4, wherein the host device is further utilized for determining an operating status of the touch control device according to data outputted by the data acquisition module.

6. The testing system of claim 4, wherein meanings of the plurality of operating stages are predefined in the host device and the controller.

7. The testing system of claim 4, further comprising a connection interface between the host device and the data acquisition module, for transferring the test requirement command outputted by the host device and data outputted by the data acquisition module.

8. The testing system of claim 4, wherein the data acquisition module comprises:
a transceiver unit, for receiving the test requirement command;
a control unit, for determining data required by the host device according to the test requirement command received by the transceiver unit, to output a control signal; and
a switching unit, for selecting the operating stage from the plurality of operating stages according to the control signal, and outputting data corresponding to the operating stage via the transceiver unit.

9. The testing system of claim 4, wherein the data acquisition module is implemented in the operating firmware by program code.

10. A controller for a touch control device comprising:
a storage device, for storing an operating firmware;
a processor, for executing the operating firmware, to realize a touch control function of the touch control device; and
a data acquisition module, for outputting data corresponding to an operating stage selected from a plurality of operating stages of the processor executing the operating firmware according to a test requirement command.

11. The controller of claim 10, wherein the test requirement command is generated by a host device, and the data acquisition module outputs data corresponding to the operating stage to the host device.

12. The controller of claim 11, wherein meanings of the plurality of operating stages are predefined in the host device and the controller.

13. The controller of claim 10, wherein the data acquisition module comprises:
a transceiver unit, for receiving the test requirement command;
a control unit, for determining the operating stage corresponding to the test requirement command according to the test requirement command received by the transceiver unit, to output a control signal; and
a switching unit, for selecting the operating stage from the plurality of operating stages according to the control signal, and outputting data corresponding to the operating stage via the transceiver unit.

14. The controller of claim 10, wherein the data acquisition module is implemented in the operating firmware by program code.

15. A touch control device for an electronic device comprising:
a touch panel, for sensing a plurality of capacitances of a plurality of traces;
an analog to digital converter (ADC), for converting the plurality of capacitances sensed by the touch panel into a plurality of digital sensed data; and
a controller, comprising:
a storage device, for storing an operating firmware;
a processor, for executing the operating firmware, to output at least one motion information packet to a front-end controller of the electronic device according to the plurality of sensed data; and
a data acquisition module, for outputting data corresponding to an operating stage selected from a plurality of operating stages of the processor executing the operating firmware according to a test requirement command.

16. The touch control device of claim 15, wherein the test requirement command is generated by a host device and the data acquisition module outputs data corresponding to the operating stage to the host device.

17. The touch control device of claim 16, wherein meanings of the plurality of operating stages are predefined in the host device and the controller.

18. The touch control device of claim 15, wherein the data acquisition module comprises:
a transceiver unit, for receiving the test requirement command;
a control unit, for determining the operating stage corresponding to the test requirement command according to the test requirement command received by the transceiver unit, to output a control signal; and
a switching unit, for selecting the operating stage from the plurality of operating stages according to the control signal, and outputting data corresponding to the operating stage via the transceiver unit.

19. The touch control device of claim 15, wherein the data acquisition module is implemented in the operating firmware by program code.
